(19) United States
(12) Patent Application Publication
(10) Pub. No.: US 2004/0207990 A1
(43) Pub. Date: Oct. 21, 2004

(54) Stair-step signal routing

(76) Inventor: Andrew C. Rose, Ramona, CA (US)

Correspondence Address: Kit M. Stetina, STETINA BRUNDA GARRED & BRUCKER, Suite 250, 75 Enterprise, Aliso Viejo, CA, 92656, US

(21) Appl. No.: 10/420,485

(22) Filed: Apr. 21, 2003

(51) Int. Cl. H01R 12/16

(52) U.S. Cl. 361/790

(57) ABSTRACT

A component attached to at least two substrates is provided wherein each substrate has a conductive pattern. The conductive patterns formed on each of the substrates are identical to each other and electrically connected to each other. The conductive pattern of the top substrate is electrically connected to the component. Even though the conductive patterns of the substrates are identical to each other, the electrical signals of the component may be uniquely redistributed through stair step configuration.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention generally relates to the use of substrates to reroute a electrical circuit of a component.

The market place demands that electronic products become smaller, faster, and more reliable. In response to such demands, electrical circuit designers are continually seeking to find new and more advanced methods of manufacturing electrical circuits to meet the demands of the market place. To this end, components are often times placed in inconvenient locations in relation to other components which need to electrically communicate with each other. At times, when two electrical components are inconveniently located in relation to each other, physically they are not electrically communicable.

As a simple example, electrical components are placed on a printed circuit board wherein the electrical signals of the components may only be rerouted on an opposing side of the printed circuit board. In other words, signal routing of the electrical signal is limited to two dimensions, and the electrical signals cannot physically overlap with each other. In particular, electrical components are placed on one side of the printed circuit board with its input/output leads electrically connected to the opposing side of the printed circuit board. The opposing side of the printed circuit board contains conductive traces which are electrically connected to the input/output leads and reroutes the electrical circuit of such electrical component to other electrical components. Sometimes an input/output lead of one component cannot electrically communicate with another input/output lead of another electrical component because a conductive trace is placed therebetween. As a result, the designer must move the electrical components to another area such that the leads may be electrically connected to each other. In this regard, it is advantageous to reroute the electrical signal prior to attaching the electrical component to the printed circuit board to strategically locate the specific electrical signals of the component on the printed circuit board so as to avoid the physical limitation described above.

### BRIEF SUMMARY OF THE INVENTION

In an embodiment of the present invention, an electrical component is provided which includes a component and at least two substrates. The substrates are vertically stacked upon each other. Each substrate has an identical conductive pattern. The conductive pattern of each substrate is electrically connected to the conductive pattern of the other substrate(s). The conductive pattern of the top substrate is electrically connected to the component.

Each substrate defines opposed top and bottom surfaces. The conductive pattern comprises a first and second set of substrate pads. The first set of substrate pads is disposed on the top surface of the substrate. The second set of substrate pads is disposed on the bottom surface of the substrate. The substrate pads of the second set of each upper substrate are electrically connected to respective ones of the substrate pads of the first set of the same substrate and electrically connected to respective substrate pads of the first set of a lower substrate.

The conductive pattern further comprises conductive traces which extend out from the substrate pads of the first and second set. The conductive traces that extend out from the substrate pads of the first set terminate above conductive traces that extend out from respective ones of the substrate pads of the second set.

The conductive pattern further comprises conductive vias which are electrically connected to conductive traces which extend out from respective ones of the substrate pads of the first and second set of the same substrate. The conductive vias are plugged with conductive material. By way of example and not limitation, the conductive material may be conductive paste, conductive ink, tin, gold, silver epoxy or combinations thereof

The substrate pads of the first set of the upper substrate are arranged in identical pattern as the substrate pads of the first set of the lower substrate. The substrate pads of the second set of the upper substrate are arranged in identical pattern as the substrate pads of the second set of the lower substrate. The substrate pads of the second set of the upper substrate are arranged in identical pattern as the substrate pads of the first set of the lower substrate. The substrate pads of the second set of each upper substrate is electrically connected to respective substrate pads of the first set of the lower substrate through conductive structures. The conductive structures may be balls or screened volumes of conductive material. The conductive material may be conductive ink, conductive paste, tin, gold, silver epoxy or combinations thereof

The substrate pad may have a configuration selected from the group consisting of circular, elliptical and square.

The component maybe a substrate based semiconductor die, leadless chip carrier, or a stackable leadless chip carrier.

### BRIEF DESCRIPTION OF THE DRAWINGS

These, as well as other features of the present invention, will become more apparent upon reference to the drawings wherein:

FIG. 1 is an orthographic view of a substrate based component wherein a plurality of substrates, namely Z1-Zn, are vertically stacked upon each other;

FIG. 2 is a cross sectional view of row X2 of FIG. 1; and

FIG. 3 is a sectional top view of substrate Zn of FIG. 1;

### DETAILED DESCRIPTION OF THE INVENTION

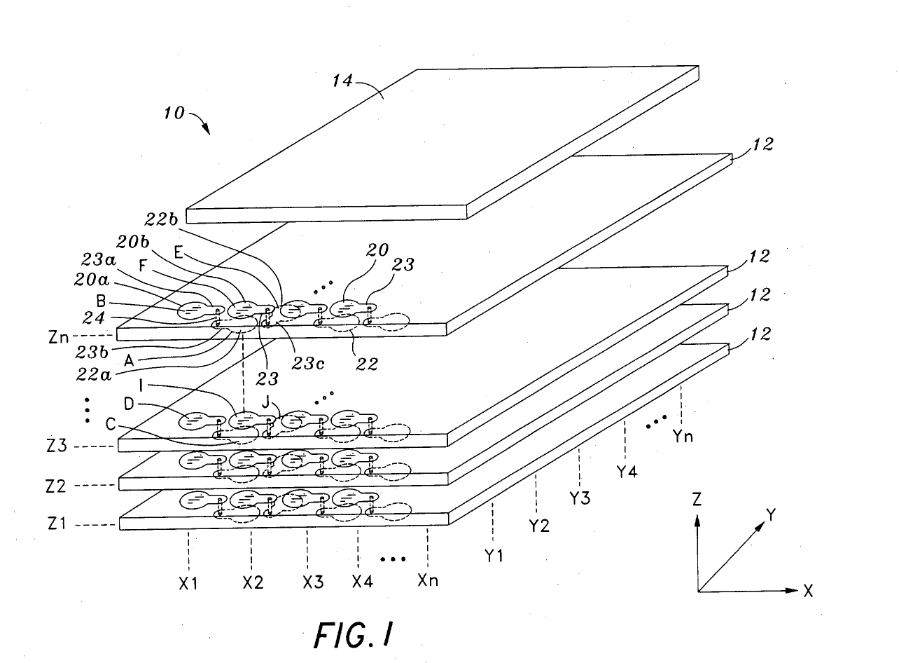

In general, the features of the present invention are applicable to all substrate based components 10 and non-substrate based components 10. In relation to substrate based components 10, as shown in FIG. 1, the same incorporates the features of the present invention into the substrate 12 itself such that electrical signals of the component 10 may be uniquely routed throughout the stack of substrates 12. In relation to the non-substrate based component 10, the same incorporates the features of the present invention into a second stage package such that the electrical signals of the component 10 may be uniquely routed. By way of illustration only and not for the purposes of limiting alternative embodiments of the present invention, the component 14 may be a substrate based component 10, non-substrate based component 10, leadless chip carrier, or a stackable leadless chip carrier.

The various figures in this description have identified a X-Y-Z coordinate system. In this regard, the positive-negative X direction will be referred to as the right and left side, respectively. The positive-negative Y direction will be referred to as the back and front side, respectively. The X-Y plane will be referred to as the horizontal plane. The positive-negative Z direction will be referred to as the top and bottom side, respectively. The Z axis will be referred to as the vertical direction.

In an embodiment of the present invention, a substrate based component 10 is provided which includes the component 14 and the stack of substrates 12. The component 14 comprises an electrical circuit.

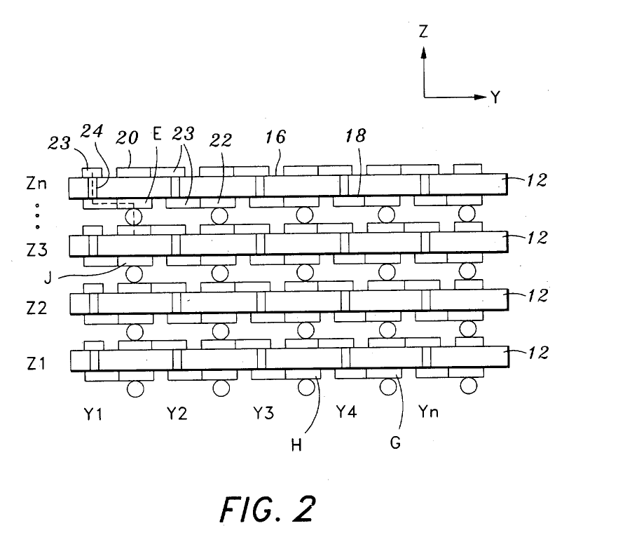

At least two substrates 12 are vertically stacked upon each other. In other words, a plurality of substrates 12 are stacked upon each other. Each substrate 12 defines opposed top and bottom surfaces 16, 18, as shown in FIG. 2. Each substrate 12 has a conductive pattern. The conductive pattern of an upper substrate 12 is electrically connected to the conductive pattern of a lower substrate 12. The conductive patterns of the upper and lower substrates 12 may have an identical configuration.

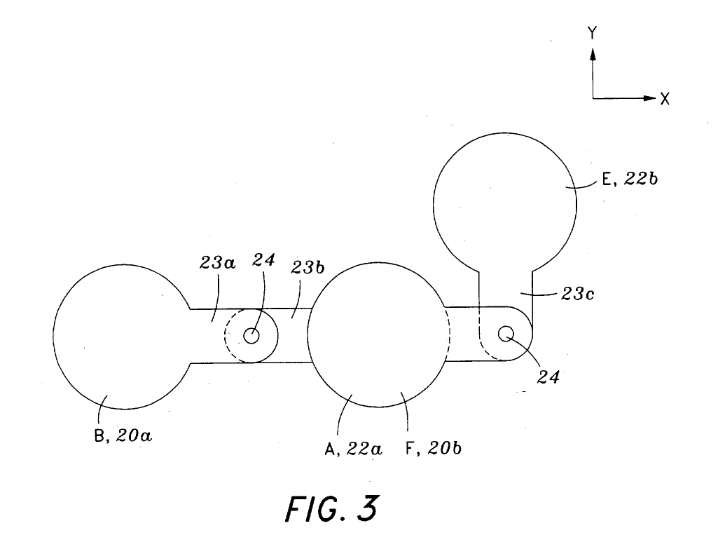

The conductive pattern of each substrate 12 comprises a first and second set of substrate pads 20, 22, as shown in FIGS. 1 and 2. The substrate pads of the first and second set 20, 22 may be fabricated from conductive material such as copper. The substrate pads of the first and second set 20, 22 may individually have any variety of configurations such as round, rectangular or any other shape used for a solder pad. For example, as shown in FIGS. 1 and 3, the substrate pads of the first and set second are shown to be circular.

Conductive traces 23 extend out from the substrate pads 20, 22 of the first and second set and terminate at respective points on the top and bottom surfaces 18, 20. Although FIG. 1 illustrates conductive traces 23 which extend out linearly from the substrate pads 20, 22 of the first and second set, the conductive traces 23 maybe curved and bent so as to be configured to reach any point on the substrate 12. As shown in FIG. 1, a conductive trace 23a extends out to the right of the substrate pad 20a of the first set at position X1, Y1, Zn. The conductive trace 23a does not contact the adjacent substrate pad 20b of the first set at X2, Y1, Zn. A conductive trace 23b extends out to the left of the substrate pad 22a. The conductive trace 23b terminates underneath conductive trace 23a, as shown in FIGS. 1 and 3. Although FIG. 1 illustrates conductive traces 23 extending out to the right of the substrate pads 20 of the first set of each substrate 12, the conductive traces may extend out in any direction in the horizontal plane (i.e., X-Y plane). For example, the substrate pad 22b of the second set at X2, Y1, Zn has a conductive trace 23c which extends out to the front of the substrate pad 22b.

The substrate pads 20, 22 of the first and second set at the same X, Y, Z position have conductive traces 23 which terminate above one another. For example, as shown in FIG. 3, conductive traces 23a and 23b extend out from substrate pads 20a and 22a of the first and second set, respectively and terminate such that their ends are vertically aligned.

Referring now to FIGS. 1 and 2, the substrate pads 20 of the first sets are disposed on the top surfaces 16 of the substrates 12. In relation to the top substrate 12, the substrate pads 20 of the first set are electrically connected to the electrical circuit of the component 14. The substrate pads 20 of the first set may have an identical pattern compared to the substrate pads of the first set 20 of the other substrates 12.

The substrate pads 22 of the second set are disposed on the bottom surface 18 of the substrate 12 and electrically connected to respective ones of the substrate pads 20 of the first set of the same substrate 12. The substrate pads 22 of the second set may have an identical pattern compared to the substrate pads 22 of the second set of the other substrates 12. Additionally, the substrate pads 22 of the second set of the upper substrate 12 are electrically connected to respective ones of the substrate pads 20 of the first set of the lower substrate 12. The substrate pads 22 of the second set of the upper substrate 12 may be coaxially aligned with respective ones of the substrate pads 20 of the first set of the lower substrate 12. Each substrate pad 22 of the second set may be physically disposed on the bottom surface 18 in fixed relation to a respective one of the substrate pads 20 of the first set of the same substrate 12. The fixed relationship between respective substrate pads 20, 22 of the first and second set may be same when comparing the substrate pads 20, 22 of the first and second set in the same X, Y position throughout the stacked substrates 12. The fixed relationship between respective substrate pads 20, 22 of the first and second set maybe different when comparing the substrate pads 20, 22 of the first and second set in different X, Y positions throughout the same substrate 12. For example, as shown in FIG. 1, the substrate pads 22 of the second set in the X1, Y1 position are located to the right of the substrate pads 20 of the first set in the X1, Y1 position throughout the stacked substrates 12; whereas, the substrate pads 22 of the second set in the X2, Y1 position are located in back of the substrate pads 20 of the first set in the X2, Y1 position.

The electrical connections between respective substrate pads 20, 22 of the first and second set may be accomplished with conductive vias 24. The conductive vias 24 may be plugged with conductive material. By way of example and not limitation, the conductive material may be selected from the group consisting of conductive paste, conductive ink, tin, gold, silver epoxy and combinations thereof. The conductive vias 24 are located perpendicular to the opposed top and bottom surfaces 16, 18 of the substrate 12. The conductive vias 24 are disposed between conductive traces 23 which extend out from respective substrate pads 20, 22 of the first and second set. The conductive vias 24 extend from the top surface 16 to the bottom surface 18 of the substrate 12. The conductive vias 24 are located at the terminations of the conductive traces 23 which extend out from respective substrate pads 20, 22 of the first and second set. The conductive traces 23 are sized and configured to be electrically connected to the vias. For example, as shown in FIG. 3, the conductive vias 24 have a smaller diameter compared to the surface areas of the conductive traces 23.

The substrate pads 22 of the second set of the upper substrate are electrically connected to the substrate pads 20 of the first set of the lower substrate 12. The electrical connection may be made with conductive structures 26 such as balls or screened volumes of conductive material. By way of example and not limitation, the conductive material may be selected from the group consisting of conductive ink, conductive paste, tin, gold, silver epoxy and combinations thereof.

The embodiment depicted in FIG. 1 merely illustrates and does not limit the possible relationships between the substrate pads 20, 22 of the first and second sets. FIG. 1 depicts four or more stacked substrates 12 identified as Z1, Z2, Z3 and Zn, depicts five or more rows and columns of substrate pads 20, 22 in the X and Y direction identified as X1, X2, X3, X4 and Xn, and Y1, Y2, Y3, Y4 and Yn, respectively. FIG. 1 illustrates a fixed relationship between the substrate pads 20, 22 of the first and second set. In particular, the substrate pad 22 of the second set at X1, Y1, Zn (referenced as A) is offset to the right side of the substrate pad 20 of the first set at X1, Y1, Zn (referenced as B), and the substrate pads 22, 20 (referenced as C, D, respectively) of the second and first set of the lower substrate at the same X, Y position (at X1, Y1, Z3) has an identical pattern. Specifically, this shows a fixed relationship between substrate pads 20, 22 of the first and second set at the same X, Y position. In this regard, more generally, the fixed relationship between substrate pads 20, 22 of the first and second set may be repeated throughout the stack of substrates in the same X, Y position, Y, Z position and/or Z, X position.

The relationship between the substrate pads 20, 22 of the first and second set may be varied throughout the stacked substrates, specifically, from row to row, column to column, and substrate to substrate. For example, the following relationship is varied from row to row. In particular, the substrate pad 22 (referenced E) of the second set is offset to the back of the substrate pad 20 (referenced F) of the first set among all substrate pads 20, 22 at the X2, Y1 position; in contrast, the substrate pad 22 (referenced A) of the second set is offset to the right side of the substrate pad 20 (referenced B) of the first set among all substrate pads 20, 22 at the X1, Y1 position.

Referring to FIG. 2, the same depicts the relationship between the substrate pads 20, 22 of the first and second set at row X2 throughout substrates Z1-Zn in FIG. 1. For clarity, FIG. 1 does not depict all of the substrate pads 20, 22 of the first and second set in row X2, particularly, the substrate pads 20, 22 of the first and second set in columns Y2-Yn. For purposes of this description, in relation to the substrate pads 20, 22 of the first and second set in columns Y2-Yn in row X2, conductive traces 23 extend to the rear of the substrate pads 20 of the first set, and conductive traces 23 extend to the front of the substrate pads 22 of the second set and terminate underneath the conductive traces 23 extending from respective substrate pads 20 of the first set, as shown in FIG. 2.

Assuming that Zn represents Z4 such that there are only four substrates, the substrate pad 20 (referenced F in FIG. 1) of the first set at X2, Y1, Z4 is electrically connected to the substrate pad 22 (referenced G in FIG. 2) of the second set at X2, Y4, Z1. In particular, the substrate pad F of the first set is electrically connected to substrate pad E of the second set through the conductive traces 23 and conducive via 24. The substrate pad E (see FIG. 2) of the second set is electrically connected to substrate pad G of the second set through the stair step configuration of substrate pads 20, 22 of the first and second set, conductive traces 23, conductive structures 26 and conductive vias 24.

The electrical pathway between substrate pads F and G is two dimensional. However, the electrical pathway may be three dimensional by varying the relationship between the substrate pads 20, 22 of the first and second set. For example, substrate pad B, as shown in FIG. 1, is electrically connected to substrate pad H, as shown in FIG. 2. In particular, as shown in FIG. 1, substrate pad B is electrically connected to substrate pad A through the conductive via 24 and conductive traces 23. Substrate pad A is electrically connected to substrate pad I through the conductive structure 26. Substrate pad I is electrically connected to substrate pad J through the conductive via 24 and conductive traces 23. Substrate pad J is electrically connected through the stair step configuration of substrate pads 20, 22, conductive traces 23, conductive structure 26, and conductive vias 24 to substrate pad H. In this regard, the stack of substrates 12 enables unique addressing of an electrical signal from the component 14 to the bottom substrate 12 even though each substrate 12 is identical to the other substrates 12.

Additional modifications and improvements of the present invention may also be apparent to those of ordinary skill in the art. Thus, the particular combination of parts and steps described and illustrated herein is intended to represent only one embodiment of the present invention, and is not intended to serve as limitations of alternative devices and methods within the spirit and scope of the invention.

1. An electrical component comprising:
a) a component; and
b) at least two substrates vertically stacked upon each other, each substrate has an identical conductive pattern, the conductive pattern of the substrates are electrically connected to each other, and the conductive pattern of the top substrate is electrically connected to the component.

2. The electrical component of claim 1 wherein the conductive patterns of the substrates have a stair step configuration.

3. The electrical component of claim 1 wherein:
a) each substrate defines opposed top and bottom surfaces; and
b) the conductive pattern comprises:
i) a first set of substrate pads disposed on the top surface of the substrate; and
ii) a second set of substrate pads disposed on the bottom surface of the substrate, the substrate pads of the second set of each upper substrate being electrically connected to respective ones of the substrate pads of the first set of such substrate and electrically connected to respective substrate pads of the first set of a lower substrate.

4. The electrical component of claim 3 wherein the conductive pattern further comprises conductive traces which extend out from the substrate pads of the first and second set, the conductive traces that extend out from the substrate pads of the first set terminate above respective ones of the conductive traces that extend out from respective ones of the substrate pads of the second set.

5. The electrical component of claim 4 wherein the conductive pattern further comprises conductive pins which are electrically connected to conductive traces which extend out from respective ones of the substrate pads of the first and second set.

6. The electrical component of claim 4 wherein the conductive traces which extend out from respective ones of the substrate pads of the first and second set are electrically connected through conductive vias.

7. The electrical component of claim 6 wherein the conductive vias are plugged with conductive material.

8. The electrical component of claim 7 wherein the conductive material is selected from the group consisting of conductive paste, conductive ink, tin, gold, silver epoxy and combinations thereof.

9. The electrical component of claim 3 wherein the substrate pads of the first set of the upper substrate are arranged in identical pattern as the substrate pads of the first set of the lower substrate.

10. The electrical component of claim 9 wherein the substrate pads of the second set of the upper substrate are arranged in identical pattern as the substrate pads of the second set of the lower substrate.

11. The electrical component of claim 10 wherein the substrate pads of the second set of the upper substrate are arranged in identical pattern as the substrate pads of the first set of the lower substrate.

12. The electrical component of claim 3 wherein the substrate pads of the second set of each upper substrate is electrically connected to respective substrate pads of the first set of the lower substrate through conductive structures.

13. The electrical component of claim 12 wherein the conductive structures are selected from a group consisting of balls and screened volume of conductive material.

14. The electrical component of claim 13 wherein the conductive material is selected from the group consisting of conductive ink, conductive paste, tin, gold, silver epoxy and combinations thereof.

15. The electrical component of claim 3 wherein the substrate pad has a configuration selected from the group consisting of circular, elliptical and square.

16. The electrical component of claim 1 wherein the component is selected from the group consisting of a substrate based semiconductor die, leadless chip carrier, and a stackable leadless chip carrier.
